(19) United States
(12) Patent Application Publication
(10) Pub. No.: US 2026/0205729 A1
(43) Pub. Date: Jul. 16, 2026

(54) SOUND-PRODUCING MODULE, AND DIGITAL LOUDSPEAKER SYSTEM AND CONTROL METHOD THEREFOR

(71) Applicant: SUZHOU SONAVOX ELECTRONICS CO., LTD., Suzhou, Jiangsu (CN)

(72) Inventor: Jianming ZHOU, Suzhou, Jiangsu (CN)

(21) Appl. No.: 19/136,229

(22) PCT Filed: Oct. 31, 2023
(86) PCT No.: PCT/CN2023/128034

§ 371 Date: Jun. 5, 2025

(30) Foreign Application Priority Data
Dec. 5, 2022 (CN) 202211545277.3
Dec. 5, 2022 (CN) 202223240795.2

(51) Int. Cl. H04R 1/28; H04R 1/00; H04R 1/06; H04R 1/40; H04R 3/12; H04R 9/02; H04R 9/04; H04R 9/06

(52) U.S. Cl. CPC H04R 1/2803; H04R 1/005; H04R 1/06; H04R 1/403; H04R 3/12; H04R 9/025; H04R 9/043; H04R 9/06; H04R 2201/028; H04R 2201/401; H04R 2201/403; H04R 2400/11

(57) ABSTRACT

Disclosed are a sound-producing module, and a digital loudspeaker system and a control method therefor. The digital loudspeaker system includes: sound-producing modules; a mounting seat having a plurality of mounting grooves, each of the mounting grooves being provided with at most one of the sound-producing modules; and a digital audio signal input PCB arranged on the mounting seat. Each of the sound-producing modules includes a frame, a magnetic circuit arranged in the frame and a sound-producing diaphragm connected to the frame, and an inner cavity is formed between the sound-producing diaphragm and the magnetic circuit. An airflow channel is formed between an inner surface of the frame and an outer surface of the magnetic circuit of each of the sound-producing modules, the mounting seat further has an airflow cavity, and each inner cavity is in communication with the airflow cavity by the airflow channel.

### CROSS-REFERENCE TO RELATED APPLICATIONS

This application is a national stage of PCT Application No. PCT/CN2023/128034, having a filing date of Oct. 31, 2023, which claims priority to Chinese Patent Application No. CN2022115452773 and CN2022232407952 filed on Dec. 5, 2022, the entire contents of which are hereby incorporated by reference.

### FIELD OF TECHNOLOGY

The present disclosure belongs to the field of loudspeakers, and in particular, to a sound-producing module, and a digital loudspeaker system and a control method therefor. The sound-producing module is typically a micro-miniature loudspeaker module suitable for forming a digital loudspeaker system.

### BACKGROUND

A loudspeaker is the most common sound-producing device. A conventional loudspeaker generally has a frame, a sound-producing diaphragm, a voice coil, a magnet, a front panel, and a T-yoke or a U-yoke. The frame, the magnet, and the front panel form a magnetic circuit. The sound-producing diaphragm and the voice coil form a vibration system. An upper end of the voice coil is attached to a lower side of the sound-producing diaphragm, and a lower end of the voice coil is arranged in a magnetic gap of the magnetic circuit. When an audio signal is inputted into the voice coil, the sound-producing diaphragm is pushed to move up and down to make sounds. Currently, conventional loudspeakers and loudspeaker systems are still driven by analog signals, and problems such as low efficiency, high power consumption, and unclarity in sound reproduction of the loudspeakers and the loudspeaker systems still cannot be fundamentally resolved. In recent years, with the rapid development of digital technologies and products, Class-D digital power amplifier products have been widely used. Although a Class-D digital power amplifier can meet requirements for reduced power consumption and heat dissipation, post-stage output of the Class-D digital power amplifier still requires a digital-to-analog conversion device. As a result, a loudspeaker structure is still required to be driven by an analog signal. Therefore, a digital loudspeaker system is required, which can organically integrate an integrated circuit technology with electroacoustic products by means of technological innovation, so that the electroacoustic products can develop from a traditional single mode to a digital, modular, and integrated mode.

### SUMMARY

The present disclosure relates to a sound-producing module, and a digital loudspeaker system and a control method therefor.

An aspect of the present disclosure provides a digital loudspeaker system, including:
N sound-producing modules, N being greater than or equal to 2;
a mounting seat having a plurality of mounting grooves, each of the mounting grooves being provided with at most one of the sound-producing modules; and
a digital audio signal input PCB for accessing a sound source signal and converting into a digital signal capable of driving the sound-producing modules to make sounds, the digital audio signal input PCB being arranged on the mounting seat;
wherein each of the sound-producing modules includes a frame, a magnetic circuit arranged in the frame, a sound-producing diaphragm connected to the frame, and a voice coil connected to the sound-producing diaphragm, the magnetic circuit has a magnetic gap, a part of the voice coil is inserted into the magnetic gap, and an inner cavity is formed between the sound-producing diaphragm and the magnetic circuit; and
an airflow channel is formed between an inner surface of the frame and an outer surface of the magnetic circuit of each of the sound-producing modules, the mounting seat further has an airflow cavity, and each inner cavity is in communication with the airflow cavity by the airflow channel.

In some embodiments, a sound-absorbing material is arranged in the airflow cavity. The sound-absorbing material is selected from porous materials, including, but not limited to, sponge, chemical fiber, and the like. A size of the airflow cavity is adjusted by controlling a volume of the sound-absorbing material, thereby adjusting product performance.

In some embodiments, below each of the mounting grooves one airflow cavity is provided, each of the mounting grooves is in communication with one airflow cavity.

In some embodiments, each of the mounting grooves has an annular bottom wall, and the frame is arranged on the bottom wall.

In some embodiments, the magnetic circuit includes a U-yoke, a magnet and a front panel that are arranged in the U-yoke; the frame has a magnetic circuit groove with open upper and lower ends, the magnetic circuit groove has a side wall extending up and down and an upper wall extending inwards from an upper edge of the side wall, an upper surface of the U-yoke is connected to the upper wall, and a side surface of the U-yoke is connected to the side wall; and the airflow channel is formed by airflow grooves arranged on the side wall and the upper wall.

In some embodiments, the airflow channel has an inlet and an outlet, the inlet is defined by the upper wall and the upper surface of the U-yoke, and the outlet is defined by the side wall and the side surface of the U-yoke.

In some embodiments, the mounting seat, the assembly frame, the diaphragm frame, and the sound convergence panel are integrally formed of plastic, respectively.

In some embodiments, the sound-producing diaphragm or the reinforcing damper is made of a material that is light in weight, and has good damping elasticity and rigidity, is resistant to high and low temperatures, and is waterproof and mildew-proof, preferably fabric, silk, or metal composite materials.

In some embodiments, the frame is provided with a lead-wire hole, and lead wires of the voice coil extend out through the lead-wire hole.

In some embodiments, the digital loudspeaker system further includes a connecting plate, the connecting plate is arranged in the frame, the connecting plate has a signal input terminal and N groups of signal output terminals, the signal input terminal is electrically connected to an output end of the digital audio signal input PCB by a wire, and each group of the signal output terminals are electrically connected to lead wires of one of the sound-producing modules.

In some embodiments, the mounting seat has an upper surface and an annular connecting flange extending upwards from an edge of the upper surface, the mounting groove extends downwards from the upper surface, the connecting plate is arranged on the upper surface and located in the connecting flange, the connecting plate is provided with N through holes, and the sound-producing modules pass through corresponding through holes.

In some embodiments, the digital loudspeaker system further includes a sound convergence panel, an edge of the sound convergence panel is fixedly connected to the connecting flange of the mounting seat, the sound convergence panel has N sound convergence portions, each of the sound-producing modules is covered with one of the sound convergence portions, a middle part of the sound convergence portion arches upwards, and the sound convergence portion is provided with one or more sound-permeable holes.

In some embodiments, a bottom of the mounting seat is provided with an accommodating groove, the digital audio signal input PCB is arranged in the accommodating groove, the digital loudspeaker system further includes a cover plate used for closing the accommodating groove, the cover plate is fixedly connected to the bottom of the mounting seat.

In some embodiments, the frame includes a diaphragm frame and an assembly frame, the magnetic circuit is arranged in the assembly frame, the diaphragm frame is fixedly connected to the assembly frame, the diaphragm is connected to the diaphragm frame, and each of the sound-producing modules further includes a reinforcing damper, the reinforcing damper is connected between the voice coil and the diaphragm frame. The reinforcing damper controls deviation of the voice coil during vertical movement in the U-yoke, thereby improving stability of the voice coil during the vertical movement. When low power is applied, the reinforcing damper can be eliminated, thereby reducing a height of a modular pure digital loudspeaker system.

In some embodiments, an upper part of the voice coil is provided with a ventilation hole, the ventilation hole is higher than the reinforcing damper.

In some embodiments, the reinforcing damper includes a body layer and a fiber layer covering the body layer, the body layer is made of rubber or silicone. The reinforcing damper has good strength and rigidity, thereby improving a control effect on deviation amplitude of the voice coil. Further, the fiber layer is trimmed into a desired fiber layer and is then placed into an injection mold where rubber or silicone is injected to form the reinforcing damper. The fiber layer is selected from one of cotton, silk, polycarbonate (PC), and Nomex.

In some embodiments, at a moment, M of the sound-producing modules make sounds, M is less than N or equal to N; and at one moment, one or more of the N sound-producing modules make sounds, and at another moment, another one or more of the N sound-producing modules make sounds. An output signal of the digital audio signal input PCB is a binary digital signal. For example, the digital audio signal input PCB generates a binary digital sequence of “0101” to implement a switching function, a pure digital system-on-chip (SOC) encoding chip outputs a switching signal to a plurality of pure digital power amplifier chips, and each digital power amplifier chip transmits an amplified power signal to the voice coil of each sound-producing module, causing the voice coil to move up and down to push the sound-producing diaphragm to make sounds, which achieves pure digital signal encoding, transmission, amplification, and digital-to-analog conversion and obtains purely digital reproduced sounds, thereby improving clarity of the reproduced sounds. When the plurality of sound-producing modules make sounds together, a sound space superposition effect is produced to enhance loudness of the overall sound.

In some embodiments, a maximum outer diameter of the sound-producing modules is less than or equal to 25 mm; and the N sound-producing modules are arranged in a linear array, a rectangular array, or an annular array.

In some embodiments, the digital audio signal input PCB includes:
a sound source access module for accessing an external sound source;
a digital signal processing module for receiving the external sound source accessed by the sound source access module and running a directional sound beamforming algorithm to directionally play sounds by the N sound-producing modules;
a digital encoding module for generating a pure digital switching signal according to output of the digital signal processing module; and
one or more power amplifier modules for driving one or more of the sound-producing modules to make sounds based on the pure digital switching signal;
wherein at one moment, one or more of the N sound-producing modules make sounds, and at another moment, another one or more of the N sound-producing modules make sounds.

In some embodiments, the digital audio signal input PCB includes a sound source access module, a digital signal processing module, a digital encoding module, N power amplifier groups, and a power supply module. The sound source access module specifically includes a Bluetooth module, a digital-to-analog conversion module, and an automotive audio bus (A2B) module, and is used for accessing an external sound source. Specifically, the Bluetooth module may acquire a sound source through Bluetooth communication. The Bluetooth module is connected to the digital signal processing module by an inter-IC sound (I²S) bus, and the acquired sound source is sent to the digital signal processing module. Wireless audio signal connection can be achieved through Bluetooth pairing, wireless signal transmission can be achieved, and a direct playback mode is performed after an audio signal is received. The digital-to-analog conversion module is specifically a digital-to-analog conversion chip, which may be connected to a conventional audio input host or mobile phones to acquire a sound source. The digital-to-analog conversion module is connected to the digital signal processing module by the I²S audio bus, and the acquired sound source is sent to the digital signal processing module. The A2B bus module is specifically an A2B bus chip. The A2B bus module is connected to the digital signal processing module by a time division multiplexing (TDM) bus, and the acquired sound source is sent to the digital signal processing module. By use of the A2B bus chip, a number and a length of connecting signal lines of each sound-producing module can be reduced, saving cable costs. The digital signal processing module is specifically a DSP chip, which may run a directional sound beamforming algorithm to implement a function of directional sound delivery by the N sound-producing modules. The signal digital processing module and the digital encoding module are electrically connected, specifically by a TDM or I²S bus. The digital encoding module is specifically a pure digital SOC encoding chip, which is electrically connected to the N power amplifier groups. Each power amplifier group includes one or more power amplifier chips for driving the corresponding sound-producing module. The power supply module supplies power to the above modules.

A second aspect of the present disclosure provides a control method for the digital loudspeaker system, including the following steps: running a directional sound beamforming algorithm to generate a pure digital switching signal, and driving one or more of the N sound-producing modules to make sounds by a power amplifier module based on the pure digital switching signal,, wherein at one moment, one or more of the N sound-producing modules make sounds, and at another moment, another one or more of the N sound-producing modules make sounds.

A third aspect of the present disclosure provides a sound-producing module, which is specifically a loudspeaker module and includes a frame, a magnetic circuit arranged in the frame, a sound-producing diaphragm connected to the frame, and a voice coil connected to the sound-producing diaphragm, wherein the magnetic circuit has a magnetic gap, part of the voice coil is inserted into the magnetic gap, and an inner cavity is formed between the sound-producing diaphragm and the magnetic circuit; and

an airflow channel is formed between an inner surface of the frame and an outer surface of the magnetic circuit, an airflow cavity is further formed in the frame, and the inner cavity and the airflow channel are communicated by the airflow cavity and are sealed by the frame.

In some embodiments, the magnetic circuit includes a U-yoke, a magnet and a front panel that are arranged in the U-yoke; the frame has a magnetic circuit groove with open upper and lower ends, the magnetic circuit groove has a side wall extending up and down and an upper wall extending inwards from an upper edge of the side wall, an upper surface of the U-yoke is connected to the upper wall, and a side surface of the U-yoke is connected to the side wall; and the airflow channel is formed by airflow grooves arranged on the side wall and the upper wall.

In some embodiments, the airflow channel has an inlet and an outlet, the inlet is defined by the upper wall and the upper surface of the U-yoke, and the outlet is defined by the side wall and the side surface of the U-yoke.

In some embodiments, the frame is provided with a lead-wire hole, and lead wires of the voice coil extend out through the lead-wire hole.

In some embodiments, the frame includes an assembly frame and a bottom cover fixedly connected to each other, the airflow cavity is formed in the bottom cover, and the magnetic circuit is arranged in the assembly frame.

In some embodiments, the bottom cover has a protruding portion protruding upwards, and the magnetic circuit is connected to the protruding portion.

In some embodiments, a sound-absorbing material is provided in the airflow cavity. The sound-absorbing material is selected from porous materials, including, but not limited to, sponge, chemical fiber, and the like. A size of the airflow cavity is adjusted by controlling a volume of the sound-absorbing material, thereby adjusting product performance.

In some embodiments, the frame further includes a diaphragm frame, the diaphragm frame is fixedly connected to an upper part of the assembly frame, the diaphragm is connected to the diaphragm frame, and the loudspeaker module further includes a reinforcing damper, the reinforcing damper is connected between the voice coil and the diaphragm frame. The reinforcing damper prevents deviation of the voice coil during vertical movement in the magnetic gap, thereby increasing displacement amplitude of the voice coil in the magnetic gap and improving sound loudness and power of the sound-producing diaphragm.

In some embodiments, an upper part of the voice coil is provided with a ventilation hole, the ventilation hole is higher than the reinforcing damper.

In some embodiments, the reinforcing damper includes a first body layer and a first fiber layer covering the first body layer, the first body layer is made of rubber or silicone. The reinforcing damper has good strength and rigidity, thereby improving a control effect on deviation amplitude of the voice coil. Furthermore, the fiber layer is trimmed into a desired first fiber layer and is then placed into an injection mold where rubber or silicone is injected to form the reinforcing damper. The first fiber layer is selected from one of cotton, silk, PC, and Nomex.

In some embodiments, the sound-producing diaphragm includes a second body layer and a second fiber layer covering the second body layer, the second body layer is made of rubber or silicone. The sound-producing diaphragm can better control movement amplitude and optimize sound performance and sound quality. Preferably, the fiber layer is trimmed into a desired second fiber layer and is then placed into an injection mold where rubber or silicone is injected to form the sound-producing diaphragm. The second fiber layer is selected from one of fabric, silk, polyetherimide (PEI), and a metal mesh.

In some embodiments, a maximum outer diameter of the loudspeaker module is less than or equal to 25 mm. The loudspeaker module is a micro-miniature loudspeaker suitable for use in a digital loudspeaker system. A sound array is formed by arranging a plurality of loudspeaker modules.

Embodiments of the present disclosure have the following advantages.

According to the digital loudspeaker system and the control method therefor in the present disclosure, when a digital signal is inputted to the N sound-producing modules, the sound-producing diaphragm vibrates to make sounds, realizing pure digital input driving, which helps improve sound efficiency, reduce power consumption, enhance clarity, and elevate quality of original sound reproduction, and the whole system is compact in structure and small in size. Moreover, the inner cavity of each sound-producing module is connected to the airflow cavity in the mounting seat by the airflow channels. When the voice coil moves up and down, airflow generated may be discharged into the airflow cavity. The inner cavity and the airflow cavity merge to form an airflow return cavity. By adjusting a volume of the airflow cavity, performance of a loudspeaker can be optimized and a bass effect can be improved. The plurality of sound-producing modules reproduce sounds in corresponding frequency bands (high frequency, medium frequency, or low frequency) respectively based on corresponding digital signals. Sound waves of the sound-producing modules are combined to form a desired sound field for reproduction.

To meet the requirements for the digital loudspeaker system, there are already some structural design solutions for micro loudspeakers. However, in these solutions, the micro loudspeaker has low power and the voice coil has small vibration amplitude in the magnetic circuit, which has certain limitations on the sound effect and quality, especially the bass effect is not good. According to the sound-producing modules in the present disclosure, the inner cavity is in communication with the airflow cavity in the frame by means of the airflow channel, airflow generated when the voice coil moves up and down may be discharged from the airflow channel into the airflow cavity, and the inner cavity and the airflow cavity merge to form an airflow return cavity. By adjusting the volume of the airflow cavity, performance of the loudspeaker can be optimized and the bass effect can be improved, which has a compact structure and a small size, and is suitable for use in digital loudspeaker systems.

### BRIEF DESCRIPTION OF THE DRAWINGS

In order to more clearly illustrate the technical solutions of the present disclosure, the accompanying drawings required to be used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a structural diagram of a loudspeaker module according to an embodiment of the present disclosure;

FIG. 2 is a partial cross-sectional view of a loudspeaker module according to an embodiment of the present disclosure;

FIG. 3 is a schematic exploded view of a loudspeaker module according to an embodiment of the present disclosure;

FIG. 4 is a structural diagram of an assembly frame in FIG. 3;

FIG. 5 is a cross-sectional view of a reinforcing damper according to an embodiment of the present disclosure;

FIG. 6 is a cross-sectional view of a sound-producing diaphragm according to an embodiment of the present disclosure;

FIG. 7 is a partial cross-sectional view of a digital loudspeaker according to an embodiment of the present disclosure;

FIG. 8 is a schematic exploded view of a digital loudspeaker according to an embodiment of the present disclosure;

FIG. 9 is a structural diagram of another sound-producing module according to an embodiment of the present disclosure;

FIG. 10 is a schematic exploded view of the sound-producing module shown in FIG. 9; and

FIG. 11 is a module diagram of a digital audio signal input PCB according to an embodiment of the present disclosure.

### REFERENCE SIGNS

1—sound-producing module (loudspeaker module); 10—bottom cover; 101—airflow cavity; 102—sound-absorbing material; 11—assembly frame; 110—magnetic circuit groove; 110a—side wall; 110b—upper wall; 110c—airflow groove; 111—lead-wire hole; 12—diaphragm frame; 13—magnetic circuit; 130—magnetic gap; 131—U-yoke; 132—magnet; 133—front panel; 14—sound-producing diaphragm; 14a—second body layer; 14b—second fiber layer; 141—dome; 142—yoke ring; 15—voice coil; 151—lead wire; 16—reinforcing damper; 16a—first body layer; 16b—first fiber layer; 17—inner cavity; 18—airflow channel; 181—inlet; 182—outlet;
2—mounting seat; 20—mounting groove; 20a—bottom wall; 21—airflow cavity; 22—connecting flange;
3—digital audio signal input PCB; 30—sound source access module; 301—Bluetooth module; 302—digital-analog conversion module; 303—A2B bus module; 31—digital signal processing module; 32—digital encoding module; 33—power amplifier group; 34—power supply module; 35—wire;
4—connecting plate; 40—through hole;
5—sound convergence panel; 50—sound convergence portion; 501—sound-permeable hole;
6—cover plate.

### DETAILED DESCRIPTION

Preferred embodiments of the present disclosure are described in detail below in conjunction with the accompanying drawings so that advantages and features of the present disclosure can be more easily understood by those skilled in the art. It should be noted that the description of these implementations is used to help understand the present disclosure, but does not constitute a limitation on the present disclosure. In addition, technical features involved in the implementations of the present disclosure described below can be combined with each other as long as they do not conflict with each other.

In the present disclosure, “inner” and “outer” are defined with reference to a center line of a voice coil of a loudspeaker. “Inner” denotes a direction proximal to the center line of the voice coil, and “outer” denotes a direction distal to the center line. Directional terms “up”, “down”, and “horizontal” are intended to help those skilled in the art understand a structure of a loudspeaker system and are not used to define a state of the loudspeaker system after it is mounted in a usage scenario. A sound-producing module may be mounted on an upper surface, a lower surface, an upright side surface, or an inclined surface of a component in a usage scenario such as a room or a car compartment.

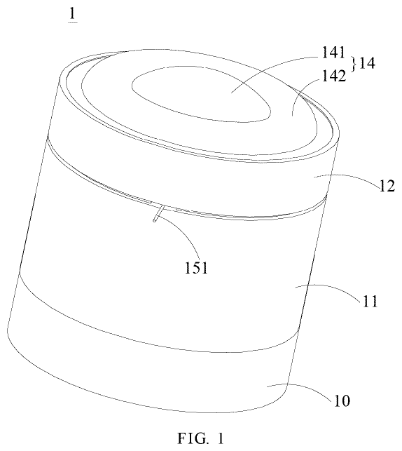

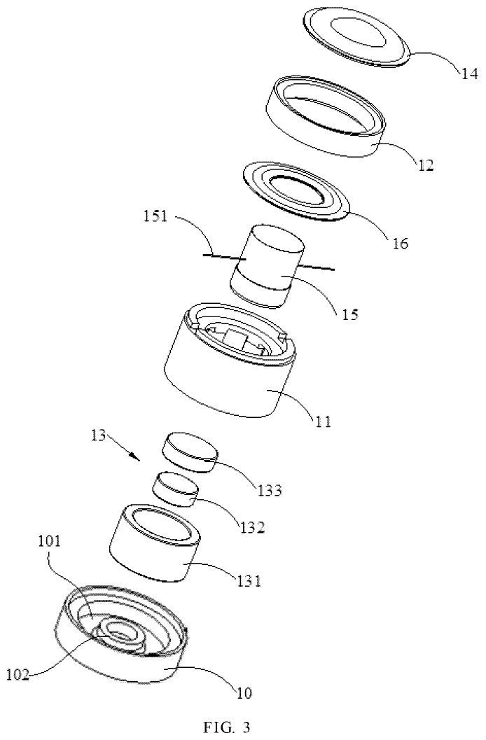

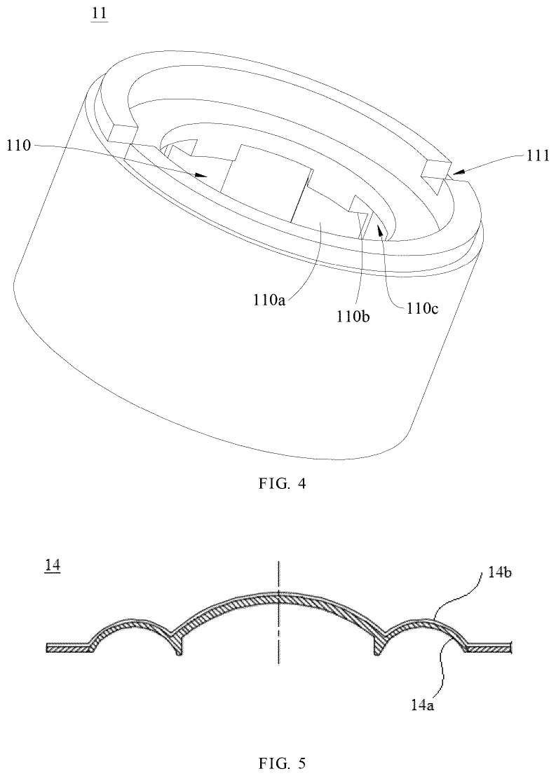

FIG. 1 to FIG. 6 illustrate a sound-producing module 1 according to an embodiment of the present disclosure, which is specifically a miniature loudspeaker module, suitable for use as a sound-producing unit of a digital loudspeaker system, and capable of converting digital audio signals into sound. A plurality of loudspeaker modules can form a sound array of the digital loudspeaker system, such as linear, rectangular, or annular. Referring to FIG. 1 to FIG. 3, the loudspeaker module 1 is in a shape of a cylinder as a whole, with a maximum outer diameter thereof less than or equal to 25 mm. The loudspeaker module 1 includes a frame, a magnetic circuit 13 arranged in the frame, a sound-producing diaphragm 14 connected to the frame, and a voice coil 15 connected to the sound-producing diaphragm 14. The frame specifically includes a bottom cover, an assembly frame 11, and a diaphragm frame 12. The magnetic circuit 13 is arranged in the assembly frame 11. The diaphragm frame 12 is fixedly connected to an upper part of the assembly frame 11. The sound-producing diaphragm 14 is connected to the diaphragm frame 12. The bottom cover is fixedly connected to a lower part of the assembly frame 11. As shown in FIG. 1, the magnetic circuit 13 has a magnetic gap 130, part (e.g., a lower part) of the voice coil 15 is inserted into the magnetic gap 130, and an inner cavity 17 is formed between the sound-producing diaphragm 14 and the magnetic circuit 13. An airflow channel 18 is formed between an inner surface of the assembly frame 11 of each loudspeaker module 1 and an outer surface of the magnetic circuit 13. An airflow cavity 101 is formed in the frame (specifically the bottom cover 10). The inner cavity 17 is in communication with the airflow cavity 101 by one corresponding airflow channel 18. Front, back, left, right, and bottom sides of the airflow cavity 101 are all sealed by the bottom cover 10, and are only in communication with the airflow channel 18 above. A sound-absorbing material 102 is provided in the airflow cavity 101. The sound-absorbing material 102 is selected from porous materials, including, but not limited to, sponge, chemical fiber, and the like. A size of the airflow cavity 102 is adjusted by controlling a volume of the sound-absorbing material 102, thereby adjusting product performance.

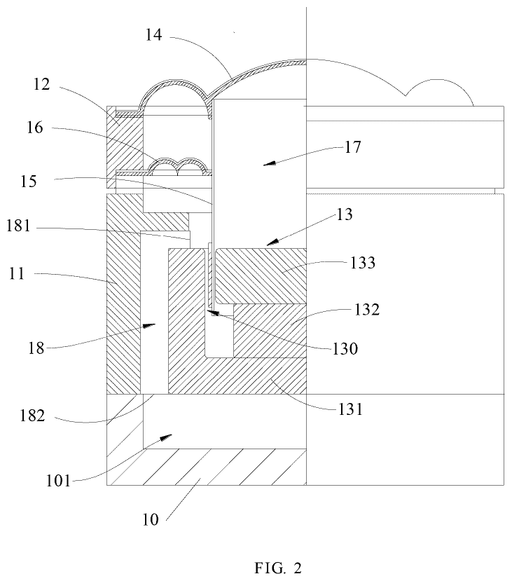

The magnetic circuit 13 includes a U-yoke 131 and a magnet 132 and a front panel 133 that are arranged in the U-yoke 131. In this embodiment, the magnet 132 is a neodymium magnet 132, which is stacked on a lower side of the front panel 133. The above magnetic gap 130 is formed between the U-yoke 131, the magnet 132, and the front panel 133. Referring to FIG. 2 to FIG. 4, the assembly frame 11 has a magnetic circuit groove 110 with upper and lower ends open, and the magnetic circuit groove 110 has a side wall 110a extending up and down and an upper wall 110b extending inwards from an upper edge of the side wall 110a. The upper wall 110b extends inwards by a distance less than a radius of the magnetic circuit groove 110, enabling the voice coil 15 to pass between the upper wall 110b and be inserted into the magnetic gap 130 below. An upper surface of the U-yoke 131 is connected to the upper wall 110b (e.g., by gluing), and a side surface of the U-yoke 131 is connected to the side wall 110a (e.g., by gluing). The above airflow channel 18 is formed by airflow grooves 110c arranged on the side wall 110a and the upper wall 110b. The airflow channel 18 has an inlet 181 and an outlet 182. The inlet 181 is defined by the upper wall 110b and the upper surface of the U-yoke 131, and the outlet 182 is defined by the side wall 110a and the side surface of the U-yoke 131.

Referring to FIG. 5, the sound-producing diaphragm 14 includes a second body layer 14a and a second fiber layer 14b covering the second body layer 14a. The second body layer 14a is made of rubber or silicone. The second fiber layer 14a is selected from one of fabric, silk, PEI, and a metal mesh. The sound-producing diaphragm 14 can better control movement amplitude and optimize sound performance and sound quality. Specifically, the fiber layer (e.g., cotton or silk) is trimmed into a desired second fiber layer 14b and is then placed into an injection mold where rubber or silicone is injected to form the sound-producing diaphragm 14.

Further, the sound-producing diaphragm 14 includes a dome 141 in the middle and a yoke ring 142 extending outwards from an outer edge of the dome 141. An outer edge of the yoke ring 142 is fixedly connected to the diaphragm frame 12. The dome 141 is generally in the shape of a hemisphere with a central portion arching upwards. A part between an inner edge and the outer edge of the yoke ring 142 gradually arches upwards. Generally, a height of the yoke ring 142 is less than that of the dome 141. An upper end of the voice coil 15 is fixedly connected to the outer edge of the dome 141 of the diaphragm and/or the inner edge of the yoke ring 142.

Each loudspeaker module 1 further includes a reinforcing damper 16, and the reinforcing damper 16 is connected between the voice coil 15 and the diaphragm frame 12. Specifically, the reinforcing damper 16 has a central hole, the voice coil 15 passes through the central hole, and an outer edge of the voice coil 15 is fixedly connected to the diaphragm frame 12. An upper part of the voice coil 15 (specifically a part higher than the reinforcing damper 16) is provided with a ventilation hole (not shown). The ventilation hole is higher than the reinforcing damper 16. Therefore, a closed cavity between the yoke ring 142 of the diaphragm and the damper is communicated with a cavity below the dome 141, thereby forming the above inner cavity 17 of the loudspeaker module 1. The assembly frame 11 is provided with lead-wire holes 111, and lead wires 151 of the voice coil 15 extend out through the lead-wire holes 111.

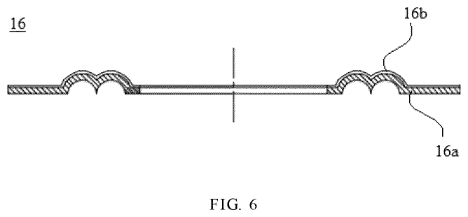

Referring to FIG. 6, the reinforcing damper 16 includes a first body layer 16a and a first fiber layer 16b covering the first body layer 16a. The first body layer 16a is made of rubber or silicone. The first fiber layer 16b is selected from one of cotton, silk, PC, and Nomex. The reinforcing damper 16 has good strength and rigidity, thereby improving a control effect on deviation amplitude of the voice coil 15. Furthermore, the fiber layer (e.g., cotton or silk) is trimmed into a desired first fiber layer 16b and is then placed into an injection mold where rubber or silicone is injected to form the reinforcing damper 16.

An inner wall of the assembly frame 11 is provided with an airflow groove capable of air discharge. Airflow generated when the voice coil 15 moves up and down may be discharged from the bottom, and the inner cavity 17 of the loudspeaker module 1 and the airflow cavity 101 of the bottom cover 10 merge to form an airflow return cavity. By adjusting an internal volume of the airflow cavity 101 (specifically by adjusting a volume of the sound-absorbing material 102 placed therein), performance of a loudspeaker with a special structure can be optimized, and the bass effect can be improved. The sound-producing diaphragm 14 is in the shape of a dome 141 with a suspension, and is also provided with a reinforcing damper 16 to increase a movement amount of the sound-producing diaphragm 14, that is, vibration amplitude. The sound-producing diaphragm 14 tightly fits the diaphragm frame 12 by the reinforcing damper 16. When the voice coil 15 moves up and down in the U-yoke 131, horizontal deviation of the voice coil 15 can be controlled.

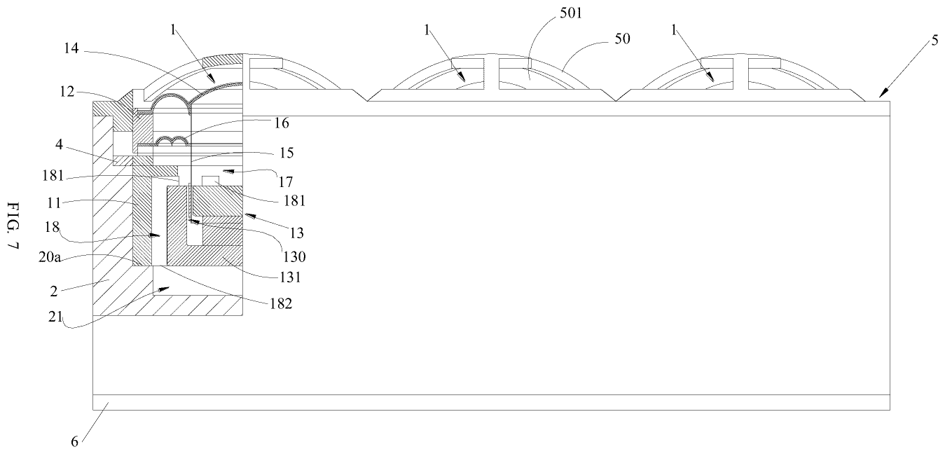

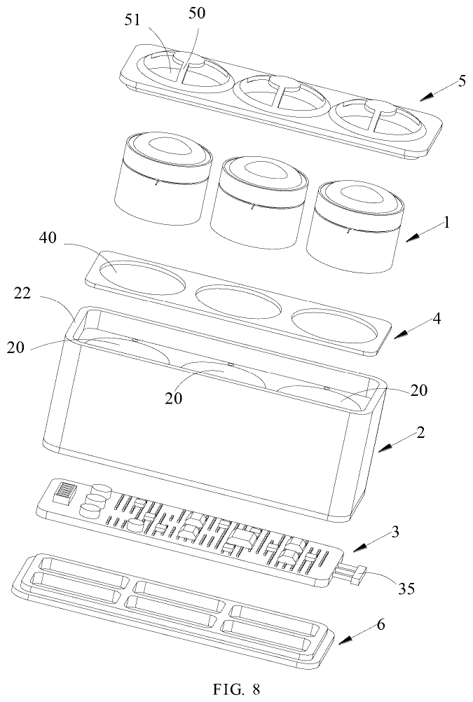

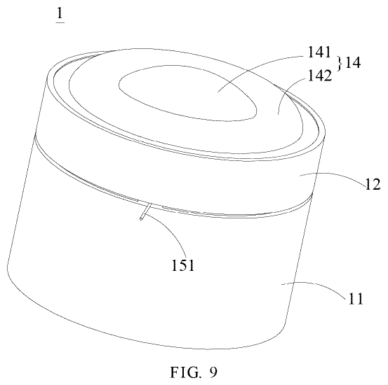

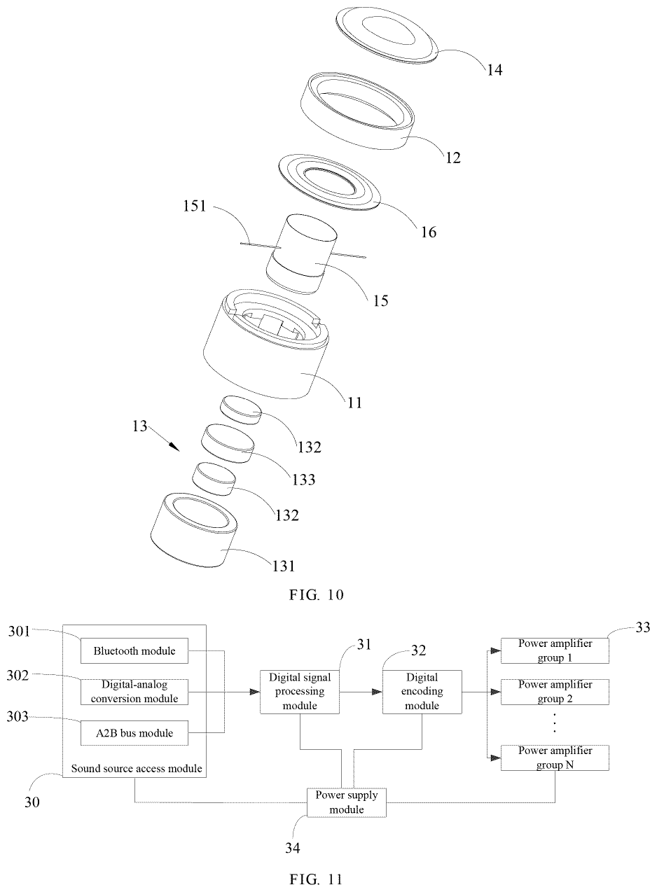

FIG. 7 to FIG. 8 illustrate a digital loudspeaker system according to an embodiment of the present disclosure, which can convert digital audio signals into sound. Referring to FIG. 7 and FIG. 8, the digital loudspeaker system includes sound-producing modules 1, a mounting seat 2, a digital audio signal input PCB 3, a connecting plate 4, a sound convergence panel 5, and a cover plate 6. The number of the sound-producing modules 1 is N, where N is greater than or equal to 2. For example, in the embodiments shown in FIG. 7 and FIG. 8, the number of the sound-producing module 1 is 3. The sound-producing modules 1 may adopt the loudspeaker module as shown in FIG. 1 to FIG. 6, or may adopt another kind of sound-producing module (as shown in FIG. 9 and FIG. 10) described below. The mounting seat 2 has a plurality of mounting grooves 20, and in each mounting groove 20, at most one sound-producing module 1 is arranged. Preferably, the number of the mounting groove 20 is the same as the number of the sound-producing module 1, that is, N. In each mounting groove 20, one sound-producing module 1 is arranged. The digital audio signal input PCB 3 is used for accessing a sound source signal and converting same into a digital signal capable of driving the sound-producing module 1 to make sounds, and the digital audio signal input PCB 3 is arranged on the mounting seat 2. At a moment, M of the sound-producing modules 1 make sounds, where M is less than N or equal to N. At one moment, one or more of the N sound-producing modules 1 make sounds, and at another moment, another one or more of the N sound-producing modules 1 make sounds. The N sound-producing modules 1 are arranged in a linear array, a rectangular array, or an annular array. In this embodiment, the sound-producing modules 1 are arranged in a ternary linear array.

Referring to FIG. 9 to FIG. 10, another kind of sound-producing module 1 includes a frame, a magnetic circuit 13 arranged in the frame, a sound-producing diaphragm 14 connected to the frame, and a voice coil 15 connected to the sound-producing diaphragm 14. The frame specifically includes a diaphragm frame 12 and an assembly frame 11. The magnetic circuit 13 is arranged in the assembly frame 11. The diaphragm frame 12 is fixedly connected to an upper part of the assembly frame 11. The sound-producing diaphragm 14 is connected to the diaphragm frame 12. As shown in FIG. 7, the magnetic circuit 13 has a magnetic gap 130, part of the voice coil 15 is inserted into the magnetic gap 130, and an inner cavity 17 is formed between the sound-producing diaphragm 14 and the magnetic circuit 13. An airflow channel 18 is formed between an inner surface of the assembly frame 11 of each sound-producing module 1 and an outer surface of the magnetic circuit 13. The mounting seat 2 further has an airflow cavity 21. Each inner cavity 17 is in communication with the airflow cavity 21 by one corresponding airflow channel 18. Further, below each mounting groove 20, one airflow cavity 21 is provided, and each airflow cavity 21 are in communication with each mounting groove 20. The plurality of airflow cavities 21 on the mounting seat 2 may be independent of each other and not communicated to each other. A sound-absorbing material 102 is provided in the airflow cavity 101. The sound-absorbing material 102 is selected from porous materials, including, but not limited to, sponge, chemical fiber, and the like. A size of the airflow cavity 102 is adjusted by controlling a volume of the sound-absorbing material 102, thereby adjusting product performance.

Each mounting groove 20 has an annular bottom wall 20a, and the assembly frame 11 is arranged on the bottom wall 20a. Further, the assembly frame 11 is fixedly connected to the annular side wall of the mounting groove 20 and the bottom wall 20a, for example, by gluing for tight fit. The magnetic circuit 13 includes a U-yoke 131 and a magnet 132 and a front panel 133 that are arranged in the U-yoke 131. In this embodiment, the magnet 132 includes two neodymium magnets 132, one of which is stacked on an upper side of the front panel 133, and the other is stacked on a lower side of the front panel 133. The magnetic gap 130 is formed between the U-yoke 131, the magnet 132, and the front panel 133. The assembly frame 11 has a magnetic circuit groove 110 with upper and lower ends open, and the magnetic circuit groove 110 has a side wall 110a extending up and down and an upper wall 110b extending inwards from an upper edge of the side wall 110a. The upper wall 110b extends inwards by a distance less than a radius of the magnetic circuit groove 110, enabling the voice coil 15 to pass between the upper wall 110b and be inserted into the magnetic gap 130 below. An upper surface of the U-yoke 131 is connected to the upper wall 110b (e.g., by gluing), and a side surface of the U-yoke 131 is connected to the side wall 110 a (e.g., by gluing). The above airflow channel 18 is formed by airflow grooves 110c arranged on the side wall 110a and the upper wall 110b. The airflow channel 18 has an inlet 181 and an outlet 182. The inlet 181 is defined by the upper wall 110b and the upper surface of the U-yoke 131, and the outlet 182 is defined by the side wall 110a and the side surface of the U-yoke 131.

The sound-producing diaphragm 14 includes a dome 141 in the middle and a yoke ring 142 extending outwards from an outer edge of the dome 141. An outer edge of the yoke ring 142 is fixedly connected to the diaphragm frame 12. The dome 141 is generally in the shape of a hemisphere with a central portion arching upwards. A part between an inner edge and the outer edge of the yoke ring 142 gradually arches upwards. Generally, a height of the yoke ring 142 is less than that of the dome 141. An upper end of the voice coil 15 is fixedly connected to the outer edge of the dome 141 of the diaphragm and/or the inner edge of the yoke ring 142. Further, the sound-producing diaphragm 14 includes a body layer and a fiber layer covering the body layer. The body layer is made of rubber or silicone. The fiber layer is selected from one of fabric, silk, PEI, and a metal mesh. The sound-producing diaphragm 14 can better control movement amplitude and optimize sound performance and sound quality. Specifically, the fiber layer (e.g., cotton or silk) is trimmed into a desired fiber layer and is then placed into an injection mold where rubber or silicone is injected to form the sound-producing diaphragm 14.

Each sound-producing module 1 further includes a reinforcing damper 16, and the reinforcing damper 16 is connected between the voice coil 15 and the diaphragm frame 12. Specifically, the reinforcing damper 16 has a central hole, the voice coil 15 passes through the central hole, and an outer edge of the voice coil 15 is fixedly connected to the diaphragm frame 12. An upper part of the voice coil 15 (specifically a part higher than the reinforcing damper 16) is provided with a ventilation hole (not shown). The ventilation hole is higher than the reinforcing damper 16. Therefore, a closed cavity between the yoke ring 142 of the diaphragm and the damper is communicated with a cavity below the dome 141, thereby forming the above inner cavity 17 of the sound-producing module 1. The assembly frame 11 is provided with lead-wire holes 111, and lead wires 151 of the voice coil 15 extend out through the lead-wire holes 111.

Further, the reinforcing damper 16 includes a body layer and a fiber layer covering the body layer. The body layer is made of rubber or silicone. The fiber layer is selected from one of cotton, silk, PC, and Nomex. The reinforcing damper 16 has good strength and rigidity, thereby improving a control effect on deviation amplitude of the voice coil 15. Furthermore, the fiber layer (e.g., cotton or silk) is trimmed into a desired first fiber layer and is then placed into an injection mold where rubber or silicone is injected to form the reinforcing damper 16.

A connecting plate 4 is arranged in the frame. The connecting plate 4 has a signal input terminal and N groups of signal output terminals, the signal input terminal is electrically connected to an output end of the digital audio signal input PCB 3 by a wire 35, and each group of the signal output terminals is electrically connected to lead wires 151 of one sound-producing module 1. Further, N groups of signal input terminals are provided, which are in one-to-one correspondence to the N groups of signal output terminals. Each group of signal input terminals conductively connects to one corresponding group of signal output terminals (e.g., by conductive metal strips) to form one signal transmission channel. Each signal transmission channel corresponds to one sound-producing module 1 and is used for transmitting an audio signal to the sound-producing module 1. Specifically, the mounting seat 2 has an upper surface and an annular connecting flange 22 extending upwards from an edge of the upper surface, the mounting groove 20 extends downwards from the upper surface, the connecting plate 4 is arranged on the upper surface and located in the connecting flange 22, the connecting plate 4 is provided with N through holes 40, and the sound-producing modules 1 pass through corresponding through holes 40.

An edge of the sound convergence panel 5 is fixedly connected to the connecting flange 22 of the mounting seat 2 and covers the N sound-producing modules 1. The sound convergence panel 5 has N sound convergence portions 50, and each sound-producing module 1 is covered with one sound convergence portion 50. The middle of the sound convergence portion 50 arches upwards, and the sound convergence portion 50 is provided with one or more sound-permeable holes 501. Specifically, the sound convergence portion 50 has a plurality of connecting ribs, the sound-permeable holes 501 are formed between the connecting ribs, and inner end portions of the plurality of connecting ribs are connected. The connecting rib is arc-shaped and extends from above the outer edge of the yoke ring 142 to above the dome 141.

The bottom of the mounting seat 2 is provided with an accommodating groove (not shown), and the digital audio signal input PCB 3 is arranged in the accommodating groove. The cover plate 6 is used for sealing the accommodating groove, and the cover plate 6 is fixedly connected to the bottom of the mounting seat 2.

Referring to FIG. 11, the digital audio signal input PCB 3 includes a sound source access module 30, a digital signal processing module 31, a digital encoding module 32, N power amplifier groups 33, and a power supply module 34. The sound source access module 30 specifically includes a Bluetooth module 301, a digital-to-analog conversion module, and an A2B bus module, and is used for accessing an external sound source. Specifically, the Bluetooth module 301 may acquire a sound source through Bluetooth communication. The Bluetooth module 301 is connected to the digital signal processing module 31 by an I²S audio bus, and the acquired sound source is sent to the digital signal processing module 31. The digital-to-analog conversion module 302 is specifically a digital-to-analog conversion chip, which may be connected to a conventional audio input host or mobile phones to acquire a sound source. The digital-to-analog conversion module 302 is connected to the digital signal processing module 31 by the I²S audio bus, and the acquired sound source is sent to the digital signal processing module 31. The A2B bus module 303 is specifically an A2B bus chip. The A2B bus module 303 is connected to the digital signal processing module 31 by a TDM bus, and the acquired sound source is sent to the digital signal processing module 31. The digital signal processing module 31 is specifically a DSP chip, which may run a directional sound beamforming algorithm to implement a function of directional sound delivery by the N sound-producing modules 1. The signal digital processing module and the digital encoding module 32 are electrically connected, specifically by a TDM or I²S bus. The digital encoding module 32 is specifically a pure digital SOC encoding chip, which is electrically connected to the N power amplifier groups 33. Each power amplifier group 33 includes one or more power amplifier chips for driving the corresponding sound-producing module 1. The power supply module 34 supplies power to the above modules. The directional beamforming algorithm and an algorithm for converting the external sound source into a digital signal to drive the N sound-producing modules 1 are not characteristic features of the present disclosure, and known algorithms may be used, such as the method disclosed in the patent CN102404672B of the applicant may be used.

An inner wall of the assembly frame 11 is provided with an airflow groove capable of air discharge. Airflow generated when the voice coil 15 moves up and down may be discharged from the bottom, and after the sound-producing module 1 is mounted in the mounting groove 20 of the mounting seat 2, the inner cavity 17 of the sound-producing module 1 and the airflow cavity 21 of the mounting seat 2 merge to form an airflow return cavity. By adjusting an internal volume of the airflow cavity 21 (specifically by adjusting a volume of the sound-absorbing material 102 placed therein), performance of a loudspeaker with a special structure can be optimized, and the bass effect can be improved. After positive and negative terminals of the lead wire 151 of the voice coil 15 of each sound-producing module 1 with a special structure are connected to a connection terminal, the power amplifier group 33 may be correspondingly conductively connected to the lead wired 151 of the voice coil 15. When a pure digital SOC encoding chip in the digital audio signal input PCB 3 outputs a pure digital switching signal of “0101”, the signal is inputted to a plurality of pure digital power amplifier chips for amplification, and then is inputted to the connecting plate 4 by means of the pure digital power amplifier chip and inputted to the voice coil 15 of the sound-producing module 1, pushing the voice coil 15 to move up and down to cause the sound-producing diaphragm 14 to make sounds. The plurality of sound-producing modules 1 reproduce sounds in corresponding frequency bands (high frequency, medium frequency, or low frequency) respectively based on corresponding digital signals. Sound waves of the sound-producing modules 1 are combined to form a desired sound field for reproduction, thereby realizing a pure digital signal input modular digital loudspeaker.

The sound-producing diaphragm 14 is in the shape of a dome 141 with a suspension, and is also provided with a reinforcing damper 16 to increase a movement amount of the sound-producing diaphragm 14, that is, vibration amplitude. The sound-producing diaphragm 14 tightly fits the diaphragm frame 12 by the reinforcing damper 16. When the voice coil 15 moves up and down in the U-yoke 131, horizontal deviation of the voice coil 15 can be controlled.

In addition, by running the directional sound beamforming algorithm by the DSP chip, pure digital directional sound delivery can be achieved. The arrangement of the airflow channel 18 and the airflow cavity 21 helps adjust the low frequency and optimize the sound quality in the low-frequency band. This product has a unique structural design and adopts pure digitalization, which helps improve sound efficiency, reduce power consumption, enhance clarity, and elevate quality of original sound reproduction.

As shown in the specification and the claims, terms “comprise” and “include” merely indicate including clearly identified steps and elements. The steps and elements do not constitute an exclusive list. A method or a device may also include other steps or elements.

Those skilled in the art may understand that, unless otherwise stated, the singular forms “a/an”, “one”, and “the” used herein may also include plural forms. It may be further understood that “a plurality of” in the present disclosure means two or more. Another quantifier is similar thereto.

It may be further understood that terms such as “first”, “second” are used to describe various information, but the information should not be limited to these terms. These terms are used only to distinguish information of a same type from one another and do not imply a particular order or level of importance. In fact, expressions such as “first” and “second” are completely interchangeable. For example, without departing from the scope of the present disclosure, first information may also be referred to as second information, and similarly, the second information may also be referred to as the first information.

In the present disclosure, unless otherwise explicitly specified and defined, the expression a first feature being “on” or “under” a second feature may be a case that the first feature is in direct contact with the second feature, or the first feature is in indirect contact with the second feature via an intermediate medium. Moreover, the expression the first feature being “over”, “above”, and “on top of” the second feature may be the case that the first feature is directly above or obliquely above the second feature, or only means that the level of the first feature is higher than that of the second feature. The expression the first feature being “below”, “underneath”, and “under” the second feature may be the case that the first feature is directly underneath or obliquely underneath the second feature, or only means that the level of the first feature is lower than that of the second feature.

The embodiments described above are only for illustrating the technical concepts and features of the present disclosure, are preferred embodiments, and are intended to make those skilled in the art able to understand the present disclosure and implement accordingly, and cannot be used to limit the protection scope of the present disclosure.

1. A digital loudspeaker system, comprising:
N sound-producing modules, N being greater than or equal to 2;
a mounting seat comprising a plurality of mounting grooves, each of the mounting grooves being provided with at most one of the sound-producing modules; and
a digital audio signal input PCB for accessing a sound source signal and converting into a digital signal capable of driving the sound-producing modules to make sounds, the digital audio signal input PCB being arranged on the mounting seat,
wherein each of the sound-producing modules comprises a frame, a magnetic circuit arranged in the frame, a sound-producing diaphragm connected to the frame, and a voice coil connected to the sound-producing diaphragm, the magnetic circuit comprising a magnetic gap, a part of the voice coil is inserted into the magnetic gap, and an inner cavity is between the sound-producing diaphragm and the magnetic circuit, and
an airflow channel is between an inner surface of the frame and an outer surface of the magnetic circuit of each of the sound-producing modules, the mounting seat further comprising an airflow cavity, and each inner cavity is in communication with the airflow cavity by the airflow channel.

2. The digital loudspeaker system according to claim 1, wherein below each of the mounting grooves one airflow cavity is provided, each of the mounting grooves is in communication with one airflow cavity, and a sound-absorbing material is provided in each airflow cavity.

3. The digital loudspeaker system according to claim 2, wherein each of the mounting grooves has an annular bottom wall, and the frame is arranged on the bottom wall.

4. The digital loudspeaker system according to claim 3, wherein the magnetic circuit comprises a U-yoke, a magnet and a front panel that are arranged in the U-yoke; the frame has a magnetic circuit groove with open upper and lower ends, the magnetic circuit groove has a side wall extending up and down and an upper wall extending inwards from an upper edge of the side wall, an upper surface of the U-yoke is connected to the upper wall, and a side surface of the U-yoke is connected to the side wall; and the airflow channel is formed by airflow grooves arranged on the side wall and the upper wall.

5. The digital loudspeaker system according to claim 4, wherein the airflow channel has an inlet and an outlet, the inlet is defined by the upper wall and the upper surface of the U-yoke, and the outlet is defined by the side wall and the side surface of the U-yoke.

6. The digital loudspeaker system according to claim 5, wherein the frame is provided with a lead-wire hole, and lead wires of the voice coil extend out through the lead-wire hole.

7. The digital loudspeaker system according to claim 6, wherein the digital loudspeaker system further comprises a connecting plate, the connecting plate is arranged in the frame, the connecting plate has a signal input terminal and N groups of signal output terminals, the signal input terminal is electrically connected to an output end of the digital audio signal input PCB by a wire, and each group of the signal output terminals are electrically connected to lead wires of one of the sound-producing modules.

8. The digital loudspeaker system according to claim 7, wherein the mounting seat has an upper surface and an annular connecting flange extending upwards from an edge of the upper surface, the mounting grooves extend downwards from the upper surface, the connecting plate is arranged on the upper surface and located in the connecting flange, the connecting plate is provided with N through holes, and the sound-producing modules pass through corresponding through holes.

9. The digital loudspeaker system according to claim 8, wherein the digital loudspeaker system further comprises a sound convergence panel, an edge of the sound convergence panel is fixedly connected to the connecting flange of the mounting seat, the sound convergence panel has N sound convergence portions, each of the sound-producing modules is covered with one of the sound convergence portions, middle parts of the sound convergence portions arch upwards, and the sound convergence portions are provided with one or more sound-permeable holes.

10. The digital loudspeaker system according to claim 1, wherein a bottom of the mounting seat is provided with an accommodating groove, the digital audio signal input PCB is arranged in the accommodating groove, the digital loudspeaker system further comprises a cover plate for closing the accommodating groove, the cover plate is fixedly connected to the bottom of the mounting seat.

11. The digital loudspeaker system according to claim 1, wherein the frame comprises a diaphragm frame and an assembly frame, the magnetic circuit is arranged in the assembly frame, the diaphragm frame is fixedly connected to the assembly frame, a diaphragm is connected to the diaphragm frame, and each of the sound-producing modules further comprises a reinforcing damper, the reinforcing damper is connected between the voice coil and the diaphragm frame.

12. The digital loudspeaker system according to claim 11, wherein an upper part of the voice coil is provided with a ventilation hole, the ventilation hole is higher than the reinforcing damper; and the reinforcing damper comprises a body layer and a fiber layer covering the body layer, the body layer is made of rubber or silicone.

13. The digital loudspeaker system according to claim 1, wherein at a moment, M of the sound-producing modules are configured to make sounds, M is less than N or equal to N; and at one moment, one or more of the N sound-producing modules are configured to make sounds, and at another moment, another one or more of the N sound-producing modules are configured to make sounds.

14. The digital loudspeaker system according to claim 1, wherein a maximum outer diameter of the sound-producing modules is less than or equal to 25 mm; and the N sound-producing modules are arranged in a linear array, a rectangular array, or an annular array.

15. The digital loudspeaker system according to claim 1, wherein the digital audio signal input PCB comprises:
a sound source access module for accessing an external sound source;
a digital signal processing module for receiving the external sound source accessed by the sound source access module and running a directional sound beamforming algorithm to directionally play sounds by the N sound-producing modules;
a digital encoding module for generating a pure digital switching signal according to output of the digital signal processing module; and
one or more power amplifier modules for driving one or more of the sound-producing modules to make sounds based on the pure digital switching signal,
wherein at one moment, one or more of the N sound-producing modules make sounds, and at another moment, another one or more of the N sound-producing modules make sounds.

16. A control method for the digital loudspeaker system according to claim 1, comprising the following steps: running a directional sound beamforming algorithm to generate a pure digital switching signal, and driving one or more of the N sound-producing modules to make sounds by a power amplifier module based on the pure digital switching signal, wherein at one moment, one or more of the N sound-producing modules make sounds, and at another moment, another one or more of the N sound-producing modules make sounds.

17. A sound-producing module, comprising:
a frame;
a magnetic circuit arranged in the frame, the magnetic circuit having a magnetic gap;
a sound-producing diaphragm connected to the frame; and
a voice coil connected to the sound-producing diaphragm, part of the voice coil being inserted into the magnetic gap,
wherein an inner cavity is between the sound-producing diaphragm and the magnetic circuit, and
an airflow channel is between an inner surface of the frame and an outer surface of the magnetic circuit, an airflow cavity is further formed in the frame, and the inner cavity and the airflow channel are communicated by the airflow cavity and are sealed by the frame.

18. The sound-producing module according to claim 17, wherein the magnetic circuit comprises a U-yoke, a magnet and a front panel that are arranged in the U-yoke; the frame has a magnetic circuit groove with open upper and lower ends, the magnetic circuit groove has a side wall extending up and down and an upper wall extending inwards from an upper edge of the side wall, an upper surface of the U-yoke is connected to the upper wall, and a side surface of the U-yoke is connected to the side wall; and the airflow channel is formed by airflow grooves arranged on the side wall and the upper wall.

19. The sound-producing module according to claim 18, wherein the airflow channel has an inlet and an outlet, the inlet is defined by the upper wall and the upper surface of the U-yoke, and the outlet is defined by the side wall and the side surface of the U-yoke.

20. (canceled)

21. The sound-producing module according to claim 18, wherein the frame comprises an assembly frame and a bottom cover, the bottom cover is connected to a lower end portion of the assembly frame and seals the lower end portion of the assembly frame, the airflow cavity is formed in the bottom cover, and the magnetic circuit is arranged in the assembly frame; a maximum outer diameter of the sound-producing module is less than or equal to 25 mm.

22-26. (canceled)
